(19) United States
(12) Patent Application Publication
(10) Pub. No.: US 2010/0051613 A1
(43) Pub. Date: Mar. 4, 2010

(54) MOUNTING TABLE STRUCTURE AND PROCESSING APPARATUS USING THE SAME

(75) Inventor: Hiroo KAWASAKI, Nirasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTON LIMITED, Tokyo (JP)

(21) Appl. No.: 12/565,488

(22) Filed: Sep. 23, 2009

Related U.S. Application Data
(63) Continuation of application No. PCT/JP08/55251, filed on Mar. 21, 2008.

(30) Foreign Application Priority Data
Mar. 23, 2007 (JP) 2007-077741

(51) Int. Cl. H05B 6/64

(52) U.S. Cl. 219/762

(57) ABSTRACT

A mounting table structure for use in a processing chamber for performing a heat treatment by using a microwave, includes a mounting table for mounting thereon a target object, the mounting table including therein a heating unit having a heating element made of a non-metal material and a supporting column standing up on a bottom portion of the processing chamber to support the mounting table. A shield member for blocking the microwave is provided on a top surface of the mounting table.

This application is a Continuation application of PCT International Application No. PCT/JP2008/055251 filed on Mar. 21, 2008, which designated the United States.

### FIELD OF THE INVENTION

The present invention relates to a processing apparatus for processing a target object such as a semiconductor wafer or the like and a mounting table structure used in the processing apparatus.

### BACKGROUND OF THE INVENTION

In general, in order to manufacture a desired semiconductor integrated circuit, various single wafer processes such as film forming process, etching process, heat treatment process, quality modification process, crystallization process and the like are repeatedly performed on a target object, e.g., a semiconductor wafer or the like. When such various processes are performed, processing gases required for the corresponding processes, e.g., a film forming gas for the film forming process; ozone gas or the like for the quality modification process; O₂ gas, an inert gas such as N₂ gas, or the like for the crystallization process, are respectively introduced into a processing chamber.

For example, in a single wafer heat treatment apparatus for performing heat treatment on semiconductor wafers one by one, a mounting table incorporating therein, e.g., a resistance heater made of a high-melting point metal such as tungsten, molybdenum or the like, is installed in a vacuum processing chamber. In this heat treatment apparatus, a predetermined processing gas is supplied after mounting a semiconductor wafer on the top surface of the mounting table, and various heat treatment processes are performed on the semiconductor wafer under predetermined processing conditions.

As described above, the resistance heater is generally made of a high-melting point metal such as tungsten, molybdenum or the like. Further, the mounting table is generally made of a ceramic material such as AlN or the like. A heavy metal or the like contained in such materials may be released into the processing chamber by thermal diffusion at a high temperature, so that contamination such as metal contamination or the like may occur on the wafer. Especially, there is an increasing concern about the contamination caused by the heavy metal thermally diffused from the high-melting point metal.

Therefore, in order to solve the above problems, Japanese Patent Laid-open Application No. 2004-356624 and No. 2005-167087 propose a heater made of a non-metal material such as a carbon wire heater or the like which is less likely to cause heavy metal contamination, and a mounting table made of quartz (glass) of high purity. Therefore, the occurrence of metal contamination or the like can be sufficiently reduced.

This mounting table structure effective in preventing metal contamination, and thus is considered to be applied to a plasma processing apparatus for processing a semiconductor wafer by a plasma generated by using a microwave.

However, in the case of applying this mounting table structure to a plasma processing using a microwave, the microwave introduced into the processing chamber is absorbed, from a conductor in the processing chamber, by the heater made of a non-metal material having a resistivity close to that of a semiconductor. In that case, local abnormal heat generation occurs in the heater, so that the heater is deteriorated and its life span is reduced.

### SUMMARY OF THE INVENTION

The present invention has been developed in order to solve the above-described problems effectively. An object of the present invention is to provide a mounting table structure capable of preventing reduction of a life span of a heating element embedded in a mounting table and made of a non-metal material by preventing abnormal heat generation or deterioration caused by a microwave, and a processing apparatus using the same.

In accordance with the present invention, there is a provided a mounting table structure for use in a processing chamber for performing a heat treatment by using a microwave, including: a mounting table for mounting thereon a target object, the mounting table including therein a heating unit having a heating element made of a non-metal material; and a supporting column standing up on a bottom portion of the processing chamber to support the mounting table, wherein a shield member for blocking the microwave is provided on a top surface of the mounting table.

In accordance with the above-described characteristics, the top surface of the mounting table is protected by providing the shield member against the microwave, so that the heating element made of a non-metal material is protected from the occurrence of abnormal heat generation or deterioration caused by the microwave. Accordingly, the reduction of its life span can be prevented.

For example, the shield member may be provided on the entire top surface of the mounting table.

Further, for example, the shield member may be provided on the remaining top surface of the mounting table other than a mounting area where the target object is mounted.

Preferably, the shield member may be further provided on a side surface of the mounting table.

Further, the shield member may be made of a semiconductor. In this case, for example, the semiconductor may be made of a material selected from the group consisting C, Si, GaAs, GaN, SiC, SiGe, InN, AlN, ZnO and ZnSe.

The shield member may also be made of a conductor. In this case, the conductor may be made of a material selected from the group consisting Al, an Al alloy, Ni, a Ni alloy, Ti, a Ti alloy, W, a W alloy and a compound thereof.

Preferably, the shield member may have a thickness of 0.01 mm to 5 mm.

Further, the shield member may have on a surface thereof a protection layer made of a heat-resistant and corrosion-resistant material.

The present invention provides a processing apparatus for performing a heat treatment on a target object, including: a vacuum processing chamber; the mounting table structure including any one of features described above; a gas introduction unit for introducing a gas into the processing chamber; and a microwave introduction unit for introducing a microwave into the processing chamber.

Preferably, the protection layer may be made of a material selected from the group consisting of Quartz, SiC and SiN.

Preferably, the protection layer may have a thickness of 1 mm to 3 mm.

### BRIEF DESCRIPTION OF THE DRAWINGS

FIG. 1 is a schematic diagram showing a processing apparatus in accordance with an embodiment of the present invention.

FIG. 2 provides a partially enlarged cross sectional view of a mounting table structure in accordance with the embodiment of the present invention.

FIG. 3 is a graph showing transmittances describing microwave shielding effects.

FIGS. 4A to 4D depict partially enlarged cross sectional views of mounting table structures in accordance with other embodiments (modifications) of the present invention.

### DETAILED DESCRIPTION OF THE EMBODIMENT

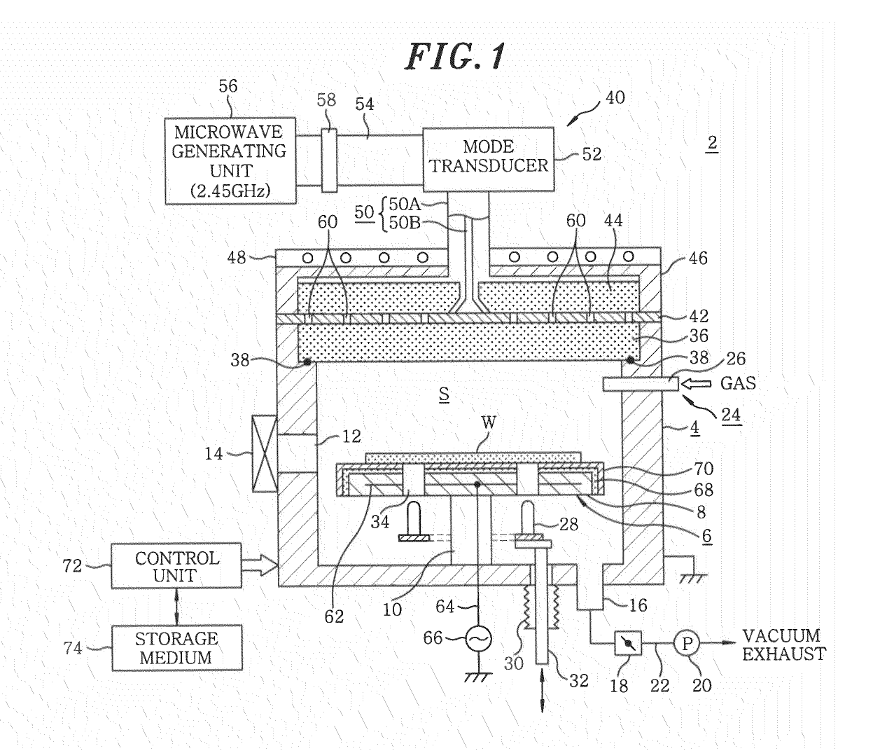

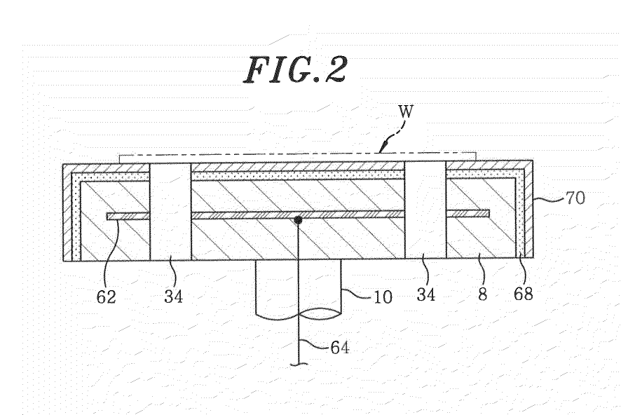

Hereinafter, the embodiments of the present invention will be described with reference to the accompanying drawings. FIG. 1 is a schematic diagram showing a processing apparatus in accordance with an embodiment of the present invention. FIG. 2 provides a partially enlarged cross sectional view of a mounting table structure in accordance with the embodiment of the present invention. Here, a plasma processing apparatus using a microwave will be described as an example of the processing apparatus.

As shown in FIG. 1, a plasma processing apparatus 2 of the present embodiment includes a processing chamber 4, e.g., formed in a cylindrical shape as a whole. A sidewall and a bottom portion of the processing chamber 4 are made of, e.g., a conductor such as aluminum or the like. The inside of the processing chamber 4 is configured as an airtightly sealed processing space S, and a plasma is generated in this processing space S. The processing chamber 4 is grounded.

A mounting table structure 6 for mounting a target object, e.g., a semiconductor wafer W, on a top surface thereof is disposed in the processing chamber 4. The mounting table structure 6, i.e., as a feature of the present invention, includes a mounting table 8 for directly mounting thereon the wafer W and a supporting column 10 standing up on a bottom portion of the processing chamber 4 and supporting the mounting table 8. A detailed description thereof will be provided later.

An opening 12 through which the wafer W can be carried in and out is formed on the sidewall of the processing chamber 4. Provided at the opening 12 is a gate valve 14 which is opened and closed when the wafer is loaded into and unloaded from inside of the processing chamber 4. Further, a gas exhaust port 16 is provided at the bottom portion of the processing chamber 4. Connected to the gas exhaust port 16 is a gas exhaust line 22 on which a pressure control valve 18 and a vacuum pump 20 are installed sequentially. With this configuration, the inside of the processing chamber 4 can be evacuated to a predetermined pressure level, if required.

Moreover, a gas introduction unit 24 for introducing a required gas into the processing chamber 4 is provided at an upper portion of the processing chamber 4. To be specific, the gas introduction unit 24 has a gas nozzle 26 which is provided through the sidewall of the processing chamber 4, so that a desired gas can be supplied from the gas nozzle 26 while its flow rate is being controlled. A plurality of gas nozzles 26 may be provided depending on types of gases employed. Further, instead of the gas nozzle 26, a shower head formed by combining, e.g., quartz tubes or the like, may be provided at the upper portion of the inside of the processing chamber 4.

Installed below the mounting table 8 is a plurality of, e.g., three lift pins 28 (only two are shown in FIG. 1) which move the wafer W vertically when the wafer W is loaded or unloaded. The lift pins 28 are moved up and down by an elevation rod 32 which is provided through the bottom portion of the processing chamber 4 while maintaining airtightness via an extendible and contractible bellows 30. Further, pin holes 34 for moving the lift pins 28 therethrough are provided in the mounting table 8.

Moreover, a ceiling portion of the processing chamber 4 is opened. A microwave transmissive ceiling plate 36 is airtightly provided at the opening of the ceiling portion via a sealing member 38 such as an O ring or the like. The ceiling plate 36 has as a base material a ceramic material, e.g., quartz plate, Al₂O₃ or the like. Further, a thickness of the ceiling plate 36 is set to be, e.g., about 20 mm, in consideration of pressure resistance.

In addition, provided on a top surface of the ceiling plate 36 is a microwave introduction unit 40 for generating a plasma in the processing chamber 4 by introducing a microwave in the processing space S inside the processing chamber 4 via the ceiling plate 36. Specifically, the microwave introduction unit 40 has a circular plate-shaped planar antenna member 42 disposed on the top surface of the ceiling plate 36, and a wave retardation member 44 is disposed on the planar antenna member 42. The wave retardation member 44 has a high-permittivity property to shorten the wavelength of the microwave, and is made of, e.g., aluminum nitride or the like.

An entire top surface of the wave retardation member 44 is enclosed by a waveguide box 46 made of a conductive chamber having a hollow cylindrical shape. The planar antenna member 42 serves as a bottom plate of the waveguide box 46, and is provided to face the mounting table 8 in the processing chamber 4. Disposed on top of the waveguide box 46 is a cooling jacket 48 which makes a coolant flow to cool the waveguide box 46.

The peripheral portions of the waveguide box 46 and the planar antenna member 42 are electrically connected with the processing chamber 4. Further, an external tube 50A of a coaxial waveguide 50 is connected to a center of the top portion of the waveguide box 46, and an internal conductor 50B of the coaxial waveguide 50 is connected to the central portion of the planar antenna member 42 via a through hole provided in the center of the wave retardation member 44. The coaxial waveguide 50 is connected to a rectangular waveguide 54 via a mode transducer 52, and the rectangular waveguide 54 is connected to a microwave generator 56 for generating a microwave of, e.g., about 2.45 GHz. With this configuration, the microwave is transmitted to the planar antenna member 42.

In other words, the microwave generator 56 is connected to the planar antenna member 42 via the rectangular waveguide 54 and the coaxial waveguide 50, so that the microwave can be transmitted thereto. Further, a matching circuit 58 for impedance matching is installed on the rectangular waveguide 54. Here, the frequency of the microwave is not limited to 2.45 GHz, but another frequency, e.g., about 8.35 GHz, may be used.

In order to deal with a wafer having a size of about 300 mm, the planar antenna member 42 is formed of a circular plate made of a conductive material having a diameter of, e.g., about 400 to 500 mm and a thickness of, e.g., about 1 to several mm. The planar antenna member 42 can be made of an aluminum or copper plate whose surface is plated with silver. Further, the planar antenna member 42 is provided with a plurality of slots 60 having, e.g., a shape of an elongated through hole. The arrangement of the slots 60 is not limited to a specific pattern. For instance, they can be arranged in concentric, spiral or radial pattern, or can be uniformly distributed over the entire surface of the planar antenna member.

The planar antenna member 42 of the present embodiment has an antenna structure of a so-called RLSA (Radial Line Slot Antenna) type, and this provides high density and low electron energy plasma.

Hereinafter, the mounting table structure 6 as a feature of the present invention will be described in more detail. As described above, the mounting table 8 is supported by the supporting column 10 standing up on the bottom portion of the processing chamber 4. Further, a heating element 62 made of, e.g., a non-metal material, which serves as a heating unit is embedded in the mounting table 8. The heating element 62 is connected to a heater power supply 66 via a wiring 64 which is provided through the supporting column 10. Here, the heating element 62 can be divided into, e.g., a plurality of concentric zones, and a temperature in each zone can be controlled independently. The heating element 62 made of a non-metal material is formed of, e.g., a carbon wire heater or the like. That is, in order to prevent the wafer W from being contaminated with a metal, it is preferable to use a material that does not contain a heavy metal.

Further, the mounting table 8 or the supporting column 10 is made of a heat-resistant and corrosion-resistant material in order to prevent the wafer W from being contaminated with the metal. To be specific, quartz (SiO₂), aluminum nitride (AlN), alumina (Al₂O₃) or the like is used. Especially, it is preferable to use quartz. For example, when quartz is used as a material of the mounting table 8, the mounting table 8 can be made by dividing the mounting table 8 into an upper part and a lower part and thermally bonding the two parts after disposing the heating element 62 therebetween. In that case, the heating element 62 can be effectively embedded in the mounting table 8.

Further, as shown in FIGS. 1 and 2, a shield member 68 for shielding the microwave is provided on the top surface of the mounting table 8. Moreover, a protection layer 70 made of a heat-resistant and corrosion-resistance material is disposed on the top surface of the shield member 68. The shield member 68 is formed in a thin plate shape. Furthermore, the shield member 68 is provided on the entire side surface of the mounting table 8 as well as on the entire top surface of the mounting table 8. With this configuration, the effect of the present invention which can prevent the heating element 62 made of a non-metal material from being damaged by the microwave is further improved.

The shield member 68 is made of a semiconductor or a conductor. Examples of the semiconductor include, e.g., C, Si, GaAs, GaN, SiC, SiGe, InN, AlN, ZnO, ZnSe and the like, and it is preferable to use a material having a high dielectric loss for a microwave due to its high thermal conductivity. Meanwhile, examples of the conductor include, e.g., Al, Al alloy, Ni, Ni alloy, Ti, Ti alloy, W, W alloy, and compound thereof, and it is preferable to use a material having a high dielectric loss for a microwave and a high thermal conductivity.

The protection layer 70 is not a necessary component in the present invention at least at the time of application of the present invention. However, it is preferable to provide the protection layer 70 in order to avoid deterioration or consumption of the shield member 68 or contamination of a wafer by the shield member 68. The protection layer 70 may be made of ceramic, e.g., quartz, SiC, SiN or the like.

In order to securely realize a microwave attenuation effect, a thickness of the shield member 68 is preferably 0.01 mm to 5 mm, and more preferably 0.5 mm to 2 mm. Further, a thickness of the protection layer 70 is preferably 1 mm to 3 mm.

Referring to FIG. 1, the entire operation of the plasma processing apparatus 2 is controlled by a control unit 72 including, e.g., a computer or the like. Computer executable programs for executing the operation (control) of the plasma processing apparatus 2 are stored in a storage medium 74 such as a flexible disk, a hard disk, a CD (Compact Disk), a flash memory, or the like. To be specific, a supply of each gas and a control of its flow rate, a supply of a microwave, a control of power, a control of a processing temperature or pressure and the like are controlled by commands from the control unit 72.

Hereinafter, the heat treatment performed by using the plasma processing apparatus 2 configured as described above will be explained.

First of all, a semiconductor wafer W is loaded into the processing chamber 4 by a transfer arm (not shown) via an open gate valve 14. By moving the lift pins 28 up and down, the wafer W is mounted on a mounting surface, i.e., the top surface of the mounting table 8 of the mounting table structure 6. The wafer W is maintained at a predetermined processing temperature by the heating element 62 provided in the mounting table 8. Further, a predetermined gas from a gas source (not shown), e.g., a film forming gas for film forming process, an etching gas for etching process or the like, is supplied at a predetermined flow rate into the processing space S inside the processing chamber 4 through the gas nozzle 26 of the gas introduction unit 24. Moreover, the pressure in the processing chamber 4 is maintained at a predetermined processing pressure level by controlling the pressure control valve 18.

The microwave generated in the microwave generator 56 is supplied to the planar antenna member 42 via the rectangular waveguide 54 and the coaxial waveguide 50 by driving the microwave generator 56 of the microwave introduction unit 40. Further, the microwave having a wavelength shortened by the wave retardation member 44 is introduced into the processing space S. Accordingly, a plasma is generated in the processing space S, and plasma processing using a predetermined plasma, e.g., film forming process, etching process or the like, is carried out. At this time, an input power of the microwave generator 56 is about 700 W to 4000 W.

Here, the microwave introduced from the planar antenna member 42 into the processing space S via the ceiling plate 36 reaches the mounting table 8. In the conventional structure, a heating element embedded in a mounting table is made of a non-metal material such as carbon wire or the like and, thus, local abnormal heat generation or the like may occur in the heating element by the microwave irradiated thereto.

However, in the mounting table structure 6 of the present embodiment, the shield member 68 formed of, e.g., a silicon plate, a carbon plate or the like, is provided on the top surface of the mounting table 8. Therefore, the microwave irradiated to the mounting table 8 is consumed, i.e., blocked, due to dielectric losses of the shield member 68. Accordingly, the microwave do not reach the heating element 62 positioned below the shield member 68. As a consequence, the occurrence of local abnormal heat generation or the like in the heating element 62 can be prevented, and the life span of the heating element 62 can be increased.

As described above, by providing the shield member 68 against a microwave on the top surface of the mounting table 8, the heating element 62 made of a non-metal material is protected from the occurrence of abnormal heat generation or consumption caused by the microwave and, therefore, the life span of the heating element 62 can be increased.

In addition, various metal members (not shown) exist inside the processing chamber 4, so that the microwave introduced into the processing chamber 4 is reflected in every direction by the corresponding metal members. For example, a rectifying plate made of aluminum alloy or the like (not illustrated) is provided at the surrounding of the mounting table 8 and reflects the microwave.

However, in the present embodiment, the shield member 68 is provided also on the sidewall of the mounting table 8. Therefore, the reflected microwave is effectively prevented from being irradiated on the side portion of the mounting table 8 and reaching the heating element 62. Accordingly, the heating element 62 can be reliably prevented from being damaged by the microwave.

Further, the shield member 68 is covered by the protection layer 70, and thus is prevented from being deteriorated or consumed by the attack of the plasma (including active species). In addition, the wafer W is prevented from being contaminated with the metal or the like by the shield member 68.

(Examination of Microwave Shielding Effect)

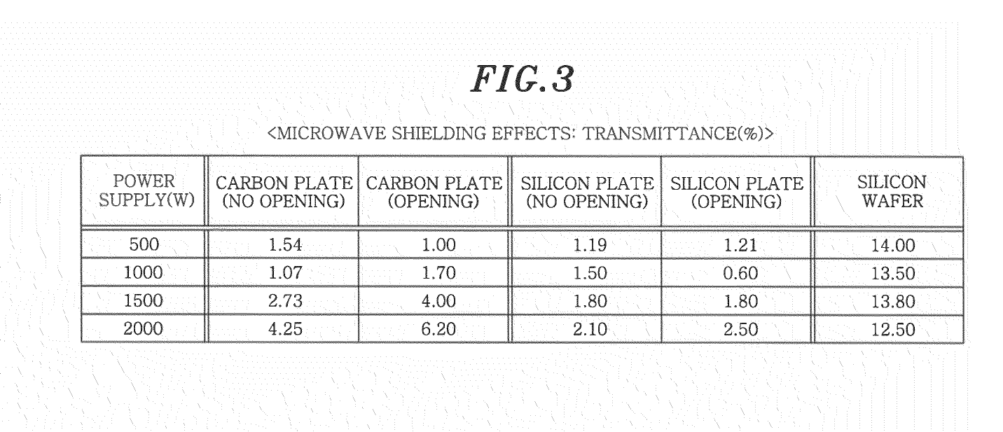

Here, the microwave shielding efficiency of the shield member 68 was examined. A result thereof will be described with reference to FIG. 3.

FIG. 3 is a graph showing transmittances describing the microwave shielding effects. Here, a carbon plate and a silicon plate, each having a thickness of 2 mm, were examined as examples of the shield member 68. Specifically, the microwave transmittances were measured in the case of providing “openings” corresponding to the pin holes 34 and in the case of no providing the “openings”. As for the “openings”, three openings having a diameter of 8 mm were provided.

A silicon substrate to be processed also serves as a microwave shielding member. For that reason, a shielding effect of a silicon wafer having a thickness of 0.8 mm was also examined. Further, the power of the microwave was varied from 500 W to 2000 W.

As can be seen from FIG. 3, the microwave transmittance of the silicon wafer was 12.50 to 14.00%. In other words, the microwave can be blocked by the silicon wafer to a certain extent. However, the shielding efficiency thereof was not sufficient.

On the other hand, the microwave transmittance of the carbon plate having a thickness of 2 mm and having no “openings” was about 1.07 to 4.25%. Further, the microwave transmittance of the carbon plate having a thickness of about 2 mm and having “openings” was 1.00 to 6.20%. The microwave transmittance of the silicon plate having a thickness of 2 mm and having no “openings” was 1.19 to 2.10%. Furthermore, the microwave transmittance of the silicon plate having a thickness of 2 mm and having “openings” was 0.60 to 2.50%. It is clear that the carbon plate and the silicon plate have transmittances considerably smaller than that of the silicon wafer and thus can block the microwave effectively.

Besides, the microwave transmittance was lower in the silicon plate than in the carbon plate. Thus, it is clear that the silicon plate is more suitable for the shield member 68.

(Modification of Mounting Table Structure)

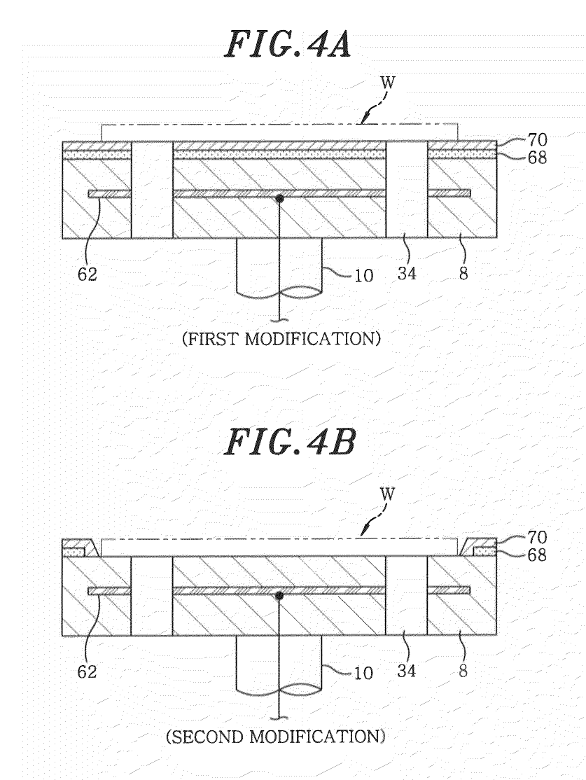

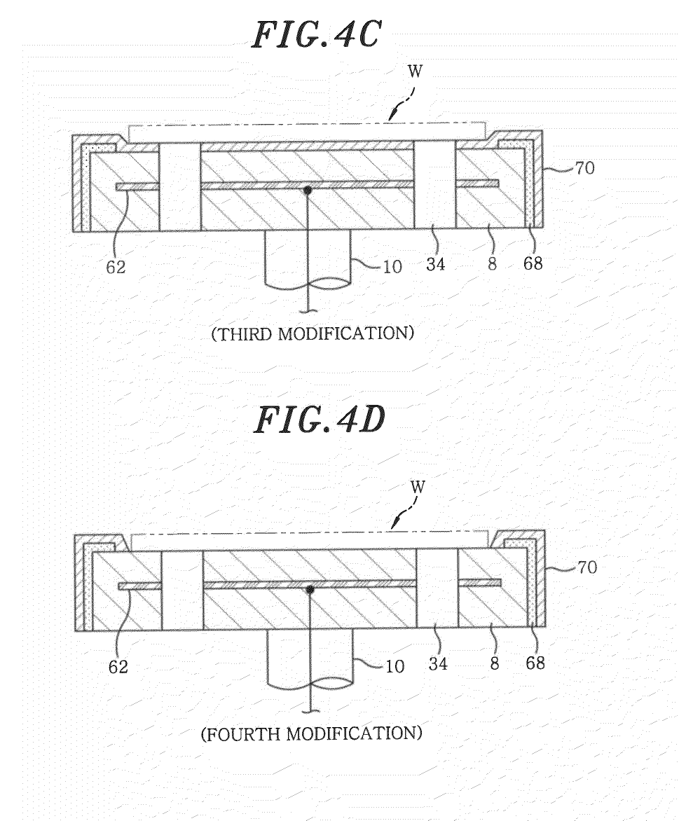

Hereinafter, a mounting table structure in accordance with another embodiment (modification) of the present invention will be described. FIGS. 4A to 4D depict partially enlarged cross sectional views of mounting table structures in accordance with other embodiments (modifications) of the present invention.

FIG. 4A shows a first modification. In the first modification, the shield member 68 and the protection layer 70 provided in the sidewall portion of the mounting table 8 are omitted from the structure shown in FIG. 2. In other words, the shield member 68 and the protection layer 70 are provided only on the entire top surface of the mounting table 8.

The first modification can provide similar operational effects as those provided by the mounting table structure shown in FIG. 2. However, a part of the microwave transmitted from the sidewall portion of the mounting table 8 may reach the heating element 62, so that the microwave shielding effect may be reduced as much as the amount of reached microwave. On the other hand, since the shield member 68 and the production layer 70 are not provided at the sidewall portion of the mounting able 8, the equipment cost can be reduced.

FIG. 4B illustrates a first modification. In the second modification, the shield member 68 and the protection layer 70 are omitted at the wafer mounting region where the wafer W is mounted from the structure of the first modification illustrated in FIG. 4A. In other words, the shield member 68 and the protection layer 70 are provided only on the remaining top surface of the mounting table 8 other than the wafer mounting region. With this structure, the microwave shielding effect can be partially made by the semiconductor wafer W to be processed (see the data of the silicon wafer shown in FIG. 3). However, the microwave irradiated from surrounding regions of the wafer W can be effectively blocked.

The second modification can provide similar operational effects as those provided by the mounting table structure shown in FIG. 2. However, the microwave is transmitted from the sidewall portion of the mounting table 8, and the microwave transmittance of the silicon wafer W is larger than that of the shield member, so that the microwave shielding effect may be reduced as much as the amount of transmitted microwave. On the other hand, since the shield member 68 and the production layer 70 are not provided at the sidewall portion of the mounting able 8 and the wafer mounting region, the equipment cost can be reduced.

FIG. 4C shows a third modification. In the third modification, the shield member 68 is omitted at the wafer mounting region on the top surface of the mounting table 8 from the structure shown in FIG. 2. In other words, only the protection layer 70 is provided on the wafer mounting region. The wafer mounting region is formed in a recess shape having a depth corresponding to the thickness of the shield member 68. In this structure, as well as in the structure of FIG. 4B, the microwave shielding effect is partially contributed by the semiconductor wafer W to be processed (see the data of the silicon wafer shown in FIG. 3). However, the microwave irradiated from surrounding regions of the wafer W can be effectively blocked.

The third modification can provide the same operational effects as those provided by the mounting table structure shown in FIG. 2. However, the microwave transmission of the silicon wafer W is larger than that of the shield member, so that the microwave shielding effect is reduced as much as the amount of transmitted microwave. On the other hand, since the shield member 68 is not provided at the wafer mounting region, the equipment cost can be reduced.

FIG. 4D depicts a fourth modification. In the fourth modification, the shield member 68 and the protection layer 70 are omitted at the wafer mounting region on the top surface of the mounting table 8 from the structure shown in FIG. 2. In other words, nothing is formed on the wafer mounting region, and the wafer mounting region is formed in a recess shape having a depth corresponding to the thicknesses of the shield member 68 and the protection layer 70. In this structure, the microwave shielding effect is partially contributed by the semiconductor wafer W to be processed (see the data of the silicon wafer of FIG. 3), as in the structure of FIGS. 4B and 4C. However, the microwave irradiated from surrounding regions of the wafer W can be effectively blocked.

The fourth modification can provide similar operational effects as those provided by the mounting table structure shown in FIG. 2. However, the microwave transmission of the silicon wafer W is larger than that of the shield member, so that the microwave shielding effect is reduced as much as the amount of transmitted microwave. On the other hand, since the shield member 68 and the protection layer 70 are not provided at the wafer mounting region of the mounting table 8, the equipment cost can be reduced.

In the above embodiment, the film forming process or the etching process has been described as an example of the heat treatment using a plasma. However, the present invention is not limited thereto, and may be applied to any heat treatment using a microwave such as an ashing process or the like.

In the above embodiment, a semiconductor wafer is used as an example of a target object. However, the present invention is not limited thereto, and may also be applied to a glass substrate, an LCD substrate, a ceramic substrate or the like.

What is claimed is:

1. A mounting table structure for use in a processing chamber for performing a heat treatment by using a microwave, comprising:
a mounting table for mounting thereon a target object, the mounting table including therein a heating unit having a heating element made of a non-metal material; and
a supporting column standing up on a bottom portion of the processing chamber to support the mounting table,
wherein a shield member for blocking the microwave is provided on a top surface of the mounting table.

2. The mounting table structure of claim 1, wherein the shield member is provided on the entire top surface of the mounting table.

3. The mounting table structure of claim 1, wherein the shield member is provided on the remaining entire top surface of the mounting table other than a mounting area where the target object is mounted.

4. The mounting table structure of claim 1, wherein the shield member is further provided on a side surface of the mounting table.

5. The mounting table structure of claim 1, wherein the shield member is made of a semiconductor.

6. The mounting table structure of claim 5, wherein the semiconductor is made of a material selected from the group consisting of C, Si, GaAs, GaN, SiC, SiGe, InN, AlN, ZnO and ZnSe.

7. The mounting table structure of claim 1, wherein the shield member is made of a conductor.

8. The mounting table structure of claim 7, wherein the conductor is made of a material selected from the group consisting of Al, an Al alloy, Ni, a Ni alloy, Ti, a Ti alloy, W, a W alloy and a compound thereof.

9. The mounting table structure of claim 1, wherein the shield member has a thickness of 0.01 mm to 5 mm.

10. The mounting table structure of claim 1, wherein the shield member has on a surface thereof a protection layer made of a heat-resistant and corrosion-resistant material.

11. A processing apparatus for performing a heat treatment on a target object, comprising:
a vacuum processing chamber;
the mounting table structure described in claim 1;
a gas introduction unit for introducing a gas into the processing chamber; and
a microwave introduction unit for a microwave into the processing chamber.

12. The mounting table structure of claim 10, wherein the protection layer is made of a material selected from the group consisting of Quartz, SiC and SiN.

13. The mounting table structure of claim 12, wherein the protection layer has a thickness of 1 mm to 3 mm.
